(19) United States
(12) Patent Application Publication
(10) Pub. No.: US 2010/0325859 A1
(43) Pub. Date: Dec. 30, 2010

(54) Method for Repairing Primary Nozzle Welds

(75) Inventors: Gary R. Poling, Forest, VA (US); Brian W. Ring, Appomattox, VA (US); Ben T. Barnett, Lynchburg, VA (US); Bradley H. Graham, Lynchburg, VA (US); Thomas N. Busic, Forest, VA (US)

Correspondence Address: Davidson, Davidson & Kappel, LLC, 485 7th Avenue, 14th Floor, New York, NY, 10018, US

(73) Assignee: AREVA NP INC., Lynchburg, VA (US)

(21) Appl. No.: 12/796,435

(22) Filed: Jun. 8, 2010

Related U.S. Application Data
(60) Provisional application No. 61/269,628, filed on Jun. 26, 2009.

(51) Int. Cl. B23P 6/00

(52) U.S. Cl. 29/402.07; 29/402.06; 29/402.13

(57) ABSTRACT

A method for providing weld inlays and onlays to primary nozzles of a nuclear reactor comprising: providing a first welding device in a first primary nozzle of the nuclear reactor; providing a second welding device in a second primary nozzle of the nuclear reactor; providing a third welding device in a third primary nozzle of the nuclear reactor; and operating the first, second and third welding devices at the same time. Other methods are also provided.

Priority to U.S. Provisional Patent Application Ser. No. 61/269,628 filed Jun. 26, 2009, is claimed, the entire disclosure of which is hereby incorporated by reference.

### BACKGROUND

The present invention relates generally to nuclear power plants, and more specifically to methods for repairing welds on primary nozzles of nuclear power plants. A nuclear power plant typically has a nuclear reactor and a reactor coolant system (RCS) for removing heat from the reactor and to generate power. The two most common types of reactors, boiling water reactors (BWRs) and pressurized water reactors (PWRs), are water-based. In a pressurized water reactor (PWR), pressurized, heated water from the reactor coolant system transfers heat to an electricity generator, which includes a secondary coolant stream boiling a coolant to power a turbine. The RCS section downstream of the electricity generators but upstream of the reactor is typically called the cold leg, and downstream of the reactor and upstream of the electricity generators is typically called the hot leg.

PWRs typically have either three hot legs and three cold legs or, more commonly in the United States, four hot legs and four cold legs. A PWR reactor vessel thus typically will have six or eight primary nozzles connecting the hot and cold legs to the reactor vessel. Tubing of the hot or cold leg typically is welded to the nozzle at a primary nozzle weld. The reactor vessel is typically made from carbon steel and the hot or cold leg piping from stainless steel. In the past, alloy 600 was used as a weld material between the reactor vessel nozzle and the hot or cold leg piping, and was felt to be a good material for use in such a dissimilar metal weld. However, primary water stress corrosion cracking (PWSCC) has been found in many of such welds, and without any mitigation, regulatory agencies may require more frequent inspection of such welds than in the past. Such inspections are expensive and time consuming, as the reactor must be shut down.

### SUMMARY OF THE INVENTION

Several companies thus offer mitigation of PWSCC of large diameter alloy 600 welds. Westinghouse markets a mechanical stress improvement process, which has several disadvantages, for example spacing constraints. Westinghouse thus also has proposed welding on the inside of the primary nozzles in conjunction with its parent company Toshiba using underwater laser beam welding.

Areva also has proposed a solution called the AEGIS inlay program that delivers robotic tooling to primary nozzles for welding operations. This program allows for welds on multiple nozzles simultaneously to minimize schedule impact, and remains in development.

One object of the present invention is to provide a time-efficient method for permitting welding on the inside of primary nozzles to further minimize schedule impact.

Another alternate or additional object of the present invention is to provide additional operations to the welding in an efficient manner.

The present invention provides a method for providing welds to primary nozzles of a nuclear reactor comprising:

providing a first welding device in a first primary nozzle of the nuclear reactor;

providing a second welding device in a second primary nozzle of the nuclear reactor;

providing a third welding device in a third primary nozzle of the nuclear reactor; and

operating the first, second and third welding devices at the same time.

The present invention also provides a method for providing welds to primary nozzles of a nuclear reactor comprising:

providing a first welding device in a first primary nozzle of the nuclear reactor;

providing a first pre-weld processing device in a second primary nozzle of the nuclear reactor; and

operating the first welding device and the first pre-weld processing device at the same time.

The present invention also provides a method for providing welds to primary nozzles of a nuclear reactor comprising:

flapping a weld of a primary nozzle; and

welding the flapped surface using a tool manipulator within the primary nozzle.

The present invention also provides a method for providing welds to primary nozzles of a nuclear reactor comprising:

providing a barrier layer at a primary nozzle using a tool manipulator within the primary nozzle; and

providing a further weld over the barrier layer using the tool manipulator or a further tool manipulator.

The present invention also provides a method for providing welds to primary nozzles of a nuclear reactor comprising:

identifying a location of a weld of a primary nozzle;

fixing a locator in the primary nozzle as a function of the weld location;

placing a tool manipulator in the primary nozzle; and

locating the tool manipulator using the locator, the tool manipulator providing a weld.

The present invention also provides a method for providing welds to primary nozzles of a nuclear reactor comprising:

providing a first working device in a first primary nozzle of the nuclear reactor;

providing a second working device in a second primary nozzle of the nuclear reactor;

providing a third working device in a third primary nozzle of the nuclear reactor; and

operating the first, second and third working devices at the same time.

### BRIEF DESCRIPTION OF THE DRAWINGS

One preferred embodiment of the present invention will be described with respect to the drawing in which:

FIG. 1 shows schematically in cross section the reactor area of a PWR nuclear reactor, as well as two of the primary nozzles;

FIG. 2 shows a repair support structure for placement in the reactor area of a reactor with eight primary nozzles to aid in performing a primary nozzle welds;

FIG. 3 shows placement of a turntable in the repair support structure;

FIG. 4 shows placement of loading tubes in the primary nozzles using the turntable, the loading tubes having plugs at one end;

FIG. 5 shows the slot of FIG. 4;

FIG. 6 shows placement of plugs using a common tool manipulator;

FIG. 7 shows schematically a non-destructive examination (NDE) device on the common tool manipulator;

FIG. 8 shows schematically a machining or grinding head for machining or grinding using the common tool manipulator;

FIG. 9 shows a preparation robot for preparation of the weld;

FIG. 10 shows schematically a gas-tungsten arc-weld device for arc-welding using the common tool manipulator to provide a weld inlay, and FIG. 10B shows a weld onlay;

FIG. 11 shows schematically a common tool manipulator in four of the primary nozzles, with the preparation robot in a fifth primary nozzle; and

FIGS. 12A, B, C, D, E, F, G and H show a preferred plan for performing a repair operation on eight primary nozzles using three common tool manipulators and one preparation robot at a same time, or four CTMs at a same time. Four CTMs and two preparation robots overall can be used.

### DETAILED DESCRIPTION OF THE PREFERRED EMBODIMENT

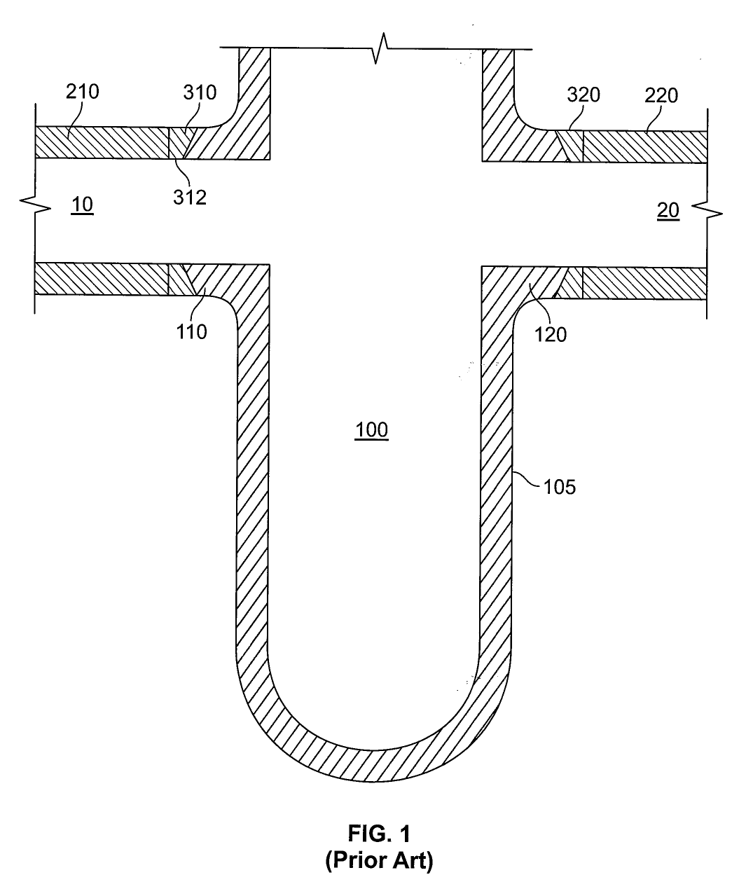

FIG. 1 shows schematically in cross section a reactor vessel 100 of a PWR nuclear reactor, as well as two of the primary nozzles 10, 20. The reactor vessel 100 is typically made of carbon steel, with a main section 105 and integral extending nozzle areas 110, 120 for the hot and cold legs all made of the same material. The vessel 100 may be a single cast piece. During construction of a nuclear power plant, tubes 210, 220, made for example of stainless steel, are welded to the nozzle areas 110, 120, respectively, with welds 310, 320. These welds 310, 320 in the past have been made of alloy 600 or alloy 82/182, which was believed to be resistant to PWSCC. However, cracking and other defects have been found in alloy 600, alloy 182 or alloy 82 present in such welds, particularly at an interior surface 312 of such welds that presents to water or steam located in the primary nozzles. The present invention thus is directed to a method for providing a further weld over the weld at surface 312 to prevent PWSCC at the welds 310, 320. The further weld can be placed directly over the older weld material, or can be a weld inlay, provided after machining or grinding away some of the old weld material. The present invention thus also advantageously provides for removal of cracks in the welds 310, 320 via machining or grinding, thus creating a new weld-appropriate surface for a weld inlay. A PWSCC resistant material such as alloy 52, 52M, 152, 152M, 52MS or 52MSS may be provided at surface 312 after pre-weld preparation so that no PWSCC susceptible materials, such as alloy 600 or alloy 82/182 presents to the steam or water in the primary nozzles.

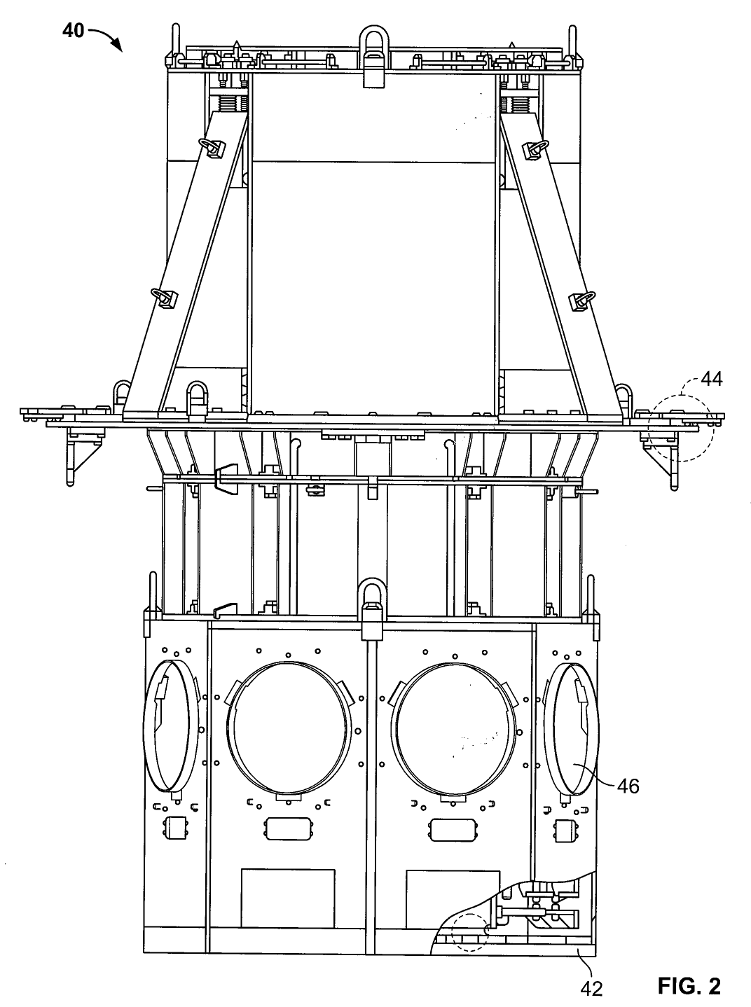

FIG. 2 shows a repair support structure 40 for placement in the reactor vessel 100 with, in this embodiment, eight primary nozzles. A repair support structure for six or four primary nozzles could also be provided. The reactor vessel, emptied of its fuel rods and internals, is drained and dried so that a dry environment for the primary nozzles 10, 20 in present. The repair support structure 40 then is placed over the reactor vessel so that flanges 44 are attached to the top of the opened reactor vessel 100. The repair support structure 40, preferably made of steel, provides a solid base 42, and eight openings 46 that align with the primary nozzles 10, 20 of the reactor vessel 100. The repair support structure 40 has the advantage that the cavity can remain flooded, so that the water still provides shielding.

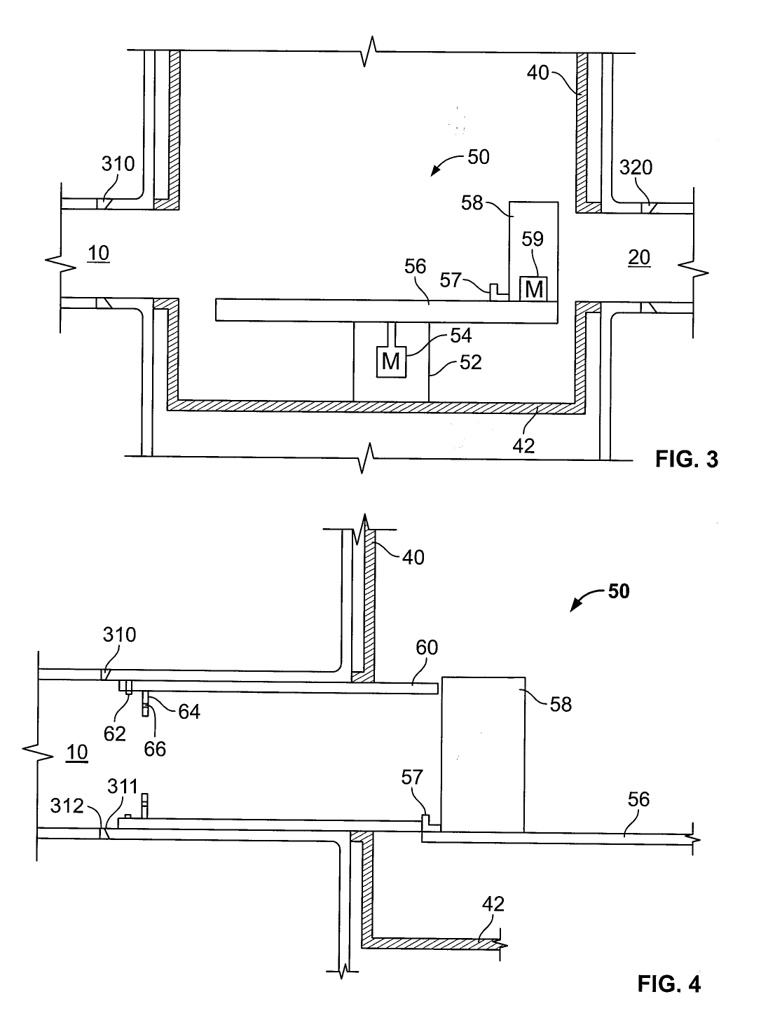

FIG. 3 shows a turntable 50 in the repair support structure 40, the turntable 50 including a base 52 for attaching to floor 42, a motor 54 to rotate a holding platform 56 and a linear actuator 58 slidable on platform 56 by a second motor 59. Work devices to be inserted into primary nozzles 10, 20 and the other six primary nozzles thus can be lowered onto holding platform 56, which may include rails or other devices to proper position the work devices. Linear actuator 59 can have pins or another type of connectors 57 for connecting the work devices to the actuator in a removable fashion. The linear actuator 58, via motor 59, then can push or slide the work devices into the primary nozzles 10, 20, deposit the work device into one of the nozzles, and then return to remove the work devices at a later time. Since the platform 56 is fully rotatable via motor 54, all eight nozzles can be accessed.

FIG. 4 shows placement of a loading tube 60 in the primary nozzle 10 using the turntable 50. Shown solely schematically, a hole or other connector on the loading tube can interact with connectors 57 to hold the loading tube on the linear actuator 58.

Each loading tube 60 can have a plurality of sliding feet 62 which can be actuated by hydraulic cylinders and can press out to lock the loading tube 60 into a fixed position with respect to the closest edge 311 on surface 312 of weld 310, for example 2 inches. The loading tube 60 preferably is placed based on known information about the location of weld 310, for example from plant design information or schematics, to be a certain distance, for example 2 inches from the expected closest edge of the weld.

Loading tube 60 also has radially extending supports 64, for example made of steel, with slot 66. Once locked, various work devices can be provided that have necks which extend through slot 66 and lock the work device with respect to the loading tube 60 via the interaction of the necks with slot 66.

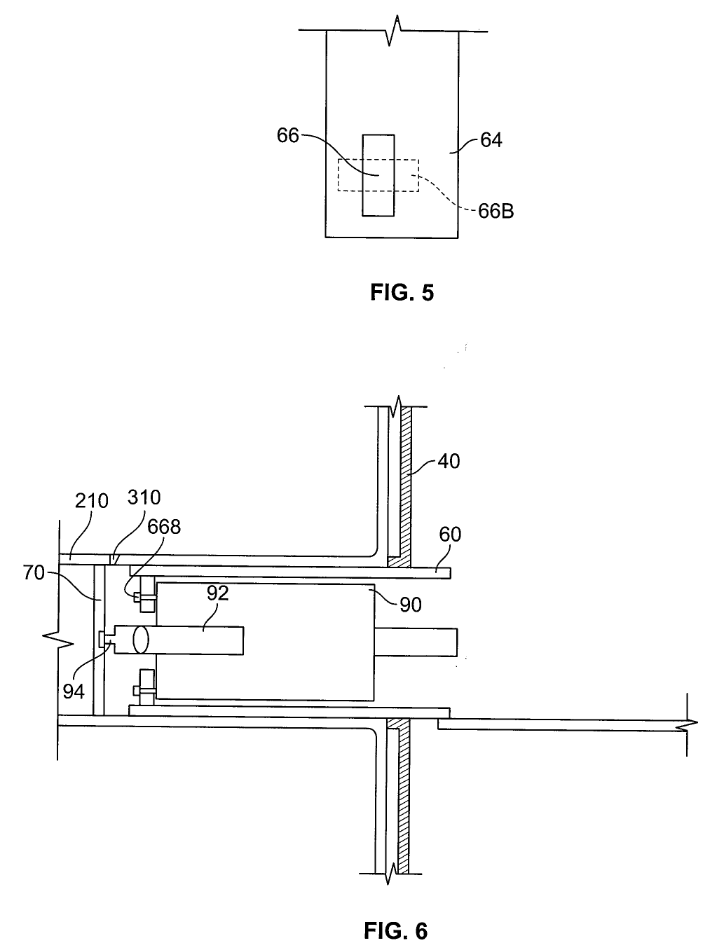

FIG. 5 shows for example one embodiment of a slot 66, through which a neck 66B can pass and then rotate and retract to lock a work device onto support 64.

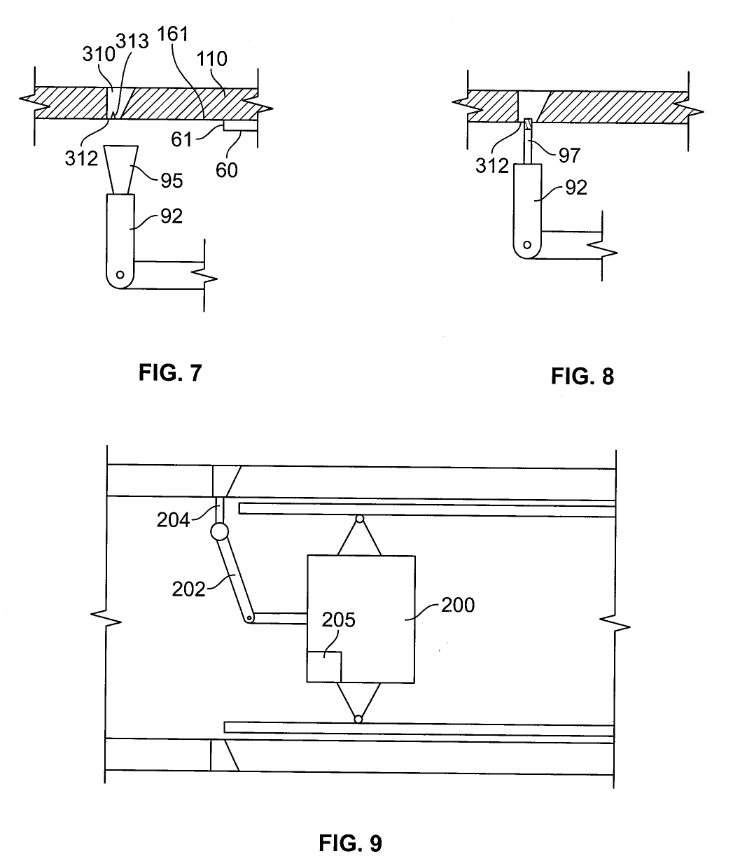

FIG. 6 shows placement of plugs 70 using a common tool manipulator. Although not shown in FIG. 4 for clarity, when first placed the loading tubes can have plugs 70 attached to the end, for example with a spring-loaded air-actuated ball detent controlled by the operator, placed in the primary nozzle. After placement of the loading tubes 60 with plugs 70, a common tool manipulator 90 can be placed on turntable 50 and inserted into the loading tube 60 using the linear actuator 58. Common tool manipulator 90 has an arm 92, preferably with at least degrees of movement, the arm 92 capable of having different tools attached to its end for different operations, for example an attachment head for plug installation, a non-destructive examination head, a machining head, and a welding head. In FIG. 7 arm 92 of common tool manipulator 90 has an attachment head 94, for example by latching onto the plug 70 after the detent is released. Attachment head 94 can move plug 70 down tube 210 to seal tube 210, the plug having a an expandable diameter, for example via a screw actuated expanding mandrel. Plug 70 can prevent materials from moving down the hot or cold legs. Once plug 70 is installed, the CTM 90 is removed via an attachment to the turntable and brought back up to the top of the reactor vessel so that the attachment head 94 can be removed and replaced by an NDE head.

Once the plugs 70 have been placed, a non-destructive examination of the weld 310 can take place. FIG. 7 shows schematically an NDE head 95 on the arm 92 of common tool manipulator 90. Advantageously, NDE head 95 may be exactly the same device as used on so-called in-service inspection (ISI) devices, for example those used a TRANS-WORLD REACTOR VESSEL EXAMINATION SYSTEM from Areva. The NDE head 95 preferably has both an eddy current sensor and ultrasonic transducer. The ultrasonic transducer can detect the physical structure of any flaws. The eddy current sensor detects when materials change, so that a transition from for example stainless steel to alloy 600/82/182 can be detected. The NDE thus can provide details of the weld 310, namely the physical location and extent of the weld and of any flaws. Since arm 92 can fully rotate 360 degrees within the tube, the circumferential, axial and radial extent of any flaws can be determined. For example, a circumferential reference point of zero degrees can be set at the top of nozzle area 110, an axial reference point of zero can be set at an end 61 of the loading tube 60, and a circumferential reference point can be set at an inner surface 161 of the nozzle area 110 at end 61. A flaw 313 thus could extend from for example 15 degrees to 32 degrees, and have a maximum axial extent on one side of 0.17 inches and at another side of 0.28 inches, and have a maximum radial depth of 0.5 inches. To prepare the flaw for remediation before a corrective weld inlay, a pre-weld operation could occur in which a machining or grinding operation occurs from 12 to 35 degrees from 0.15 to 0.30 inches and with a constant radial depth of 0.6 inches. The entire flaw is thus removed. Alternatively, depending on the type of machining or grinding used or the extent of the flaws, it may be advantageous to machine or grind all 360 degrees. A software program, such as ACCUSONEX from Areva, can be used to provide a visual three-dimensional representation of the flaws, and accurately map the locations of the weld and any flaws. Should the NDE determine that the loading tube is located too far or too close to the weld 310, a repositioning of the loading tube can occur.

FIG. 8 shows schematically a machining or grinding tool 97 for machining or grinding using the common tool manipulator arm 92. Tool 97 can machine or grind away any flaws, and also can be used to machine or grind away a small portion, for example 0.1 inch, of all of inner surface 312 of the weld 310, for example using CNC control. A vacuum can be provided with the CTM 90 to permit vacuuming of the machined away or ground material. The CTM 90 then can be removed from tube 60 and brought to the top of reactor 100. A laser profilometry head also can be provided at the CTM 90 at the same time as the machining or grinding tool 97 is attached, and is used to determine the shape of the nozzle, for example if it is not perfectly circular. The CNC control thus can be modified as the machining or grinding is occurring to ensure the proper machining or grinding depth.

FIG. 9 shows a preparation robot 200 for preparation of the weld after machining or grinding. The robot may be for example one available from the STÄUBLI Corporation, and may be used for example to flap the weld 310 to compress the weld material, and also to clean the weld 310, for example with a sponge or wipe, or perform a surface examination with a die penetrant. One advantage of the preparation robot is that certain tools used can be replaced in situ, i.e. carried and stored on the robot itself, without the robot needing to be removed from the primary nozzle. Thus during a surface exam, a sponge or wipe 205 can be used to perform a further pre-weld operation, and then a surface examination head 204 can be used after the sponge or wipe 205 without withdrawing the robot 200.

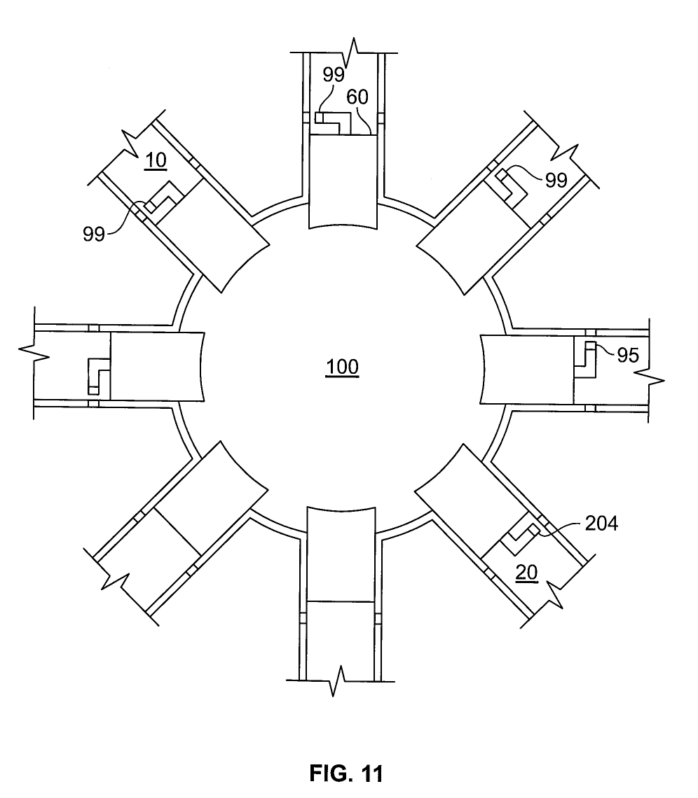

While the robot 200 is operating, the machining or grinding head 97 of CTM 90 can be removed manually and an arc-welding device installed on manipulator arm 92. FIG. 11 shows schematically an arc-weld device 99 installed on arm 92 for arc-welding using the common tool manipulator 90, for example a gas-tungsten arc welding head. An inlay 410 can be laid over any PWSCC susceptible alloy, and can extend a distance X axially beyond the weld 310, for example 0.25 inches. The weld inlay may be made of alloy 52MS for example, and have a thickness of at least 0.13 inches for example. After the welding of the inlay, a machining or grinding can occur. Any machined flaws can also be filled with weld material. Once the weld inlay 410 is placed, a final inspection can occur using preparation robot 200.

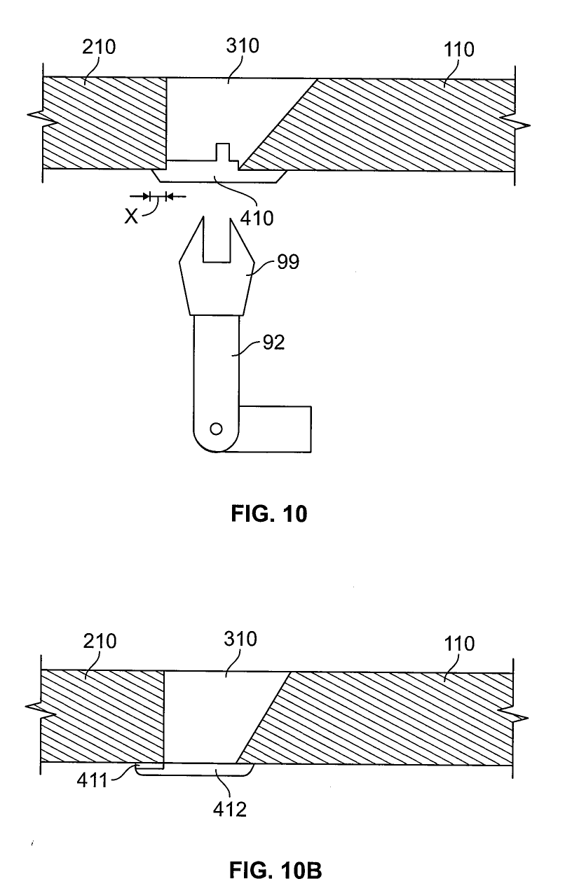

FIG. 10B shows an alternate weld 412 to the weld inlay 410, in which the weld 412 is placed over the weld 310 without machining or grinding, a so-called onlay. With both the inlay 420 and the alternate onlay weld 412, a barrier layer 411 made of for example alloy 309 can be placed over any stainless steel material, and the alloy 52MS, for example, then placed over the alloy 309 barrier layer 411. The barrier layer 411 is helpful since certain alloys such as 52MS may not weld well directly on stainless steel material with high sulfur content. Alternately the barrier layer 311 can be both alloy 309 over the stainless steel and carbon areas, and alloy 82 over the weld 310.

It should be noted that in some embodiments of the present invention, the machining or grinding step is not necessary, and the arc-weld device 99 can place the new weld material directly over weld 310 without machining or grinding, i.e. without performing a weld inlay operation.

FIG. 11 shows schematically common tool manipulators in four of the primary nozzles, with the preparation robot in a fifth primary nozzle. Advantageously, three CTMs 90 can be welding, while a fourth can be machining. The preparation robot 200 can be flapping the weld of yet another primary nozzle 20. In one preferred embodiment, only four total devices, three CTMs and one preparation robot are used.

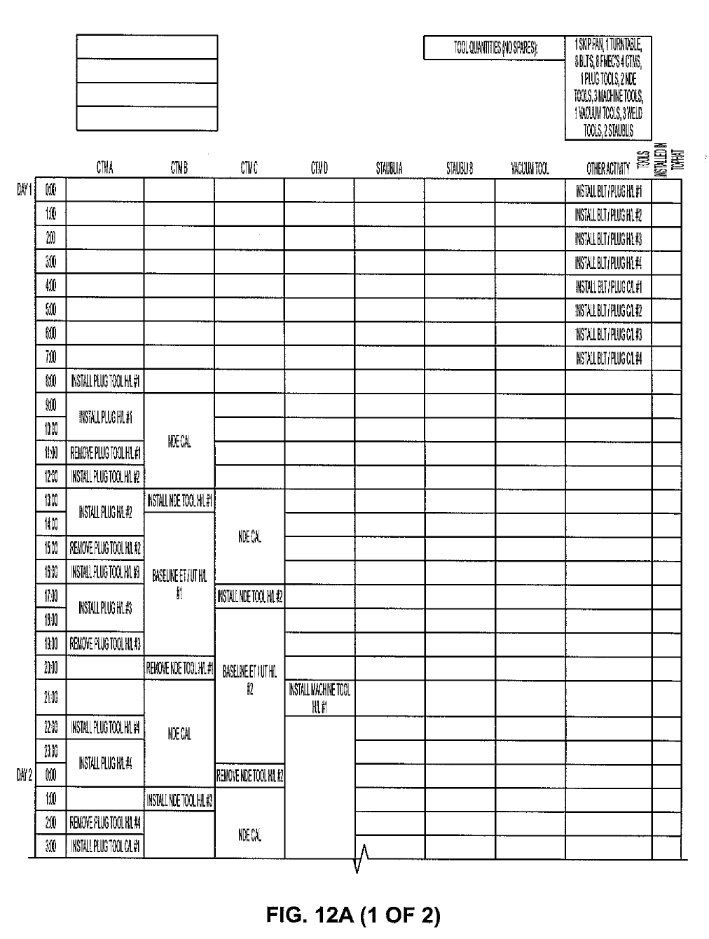

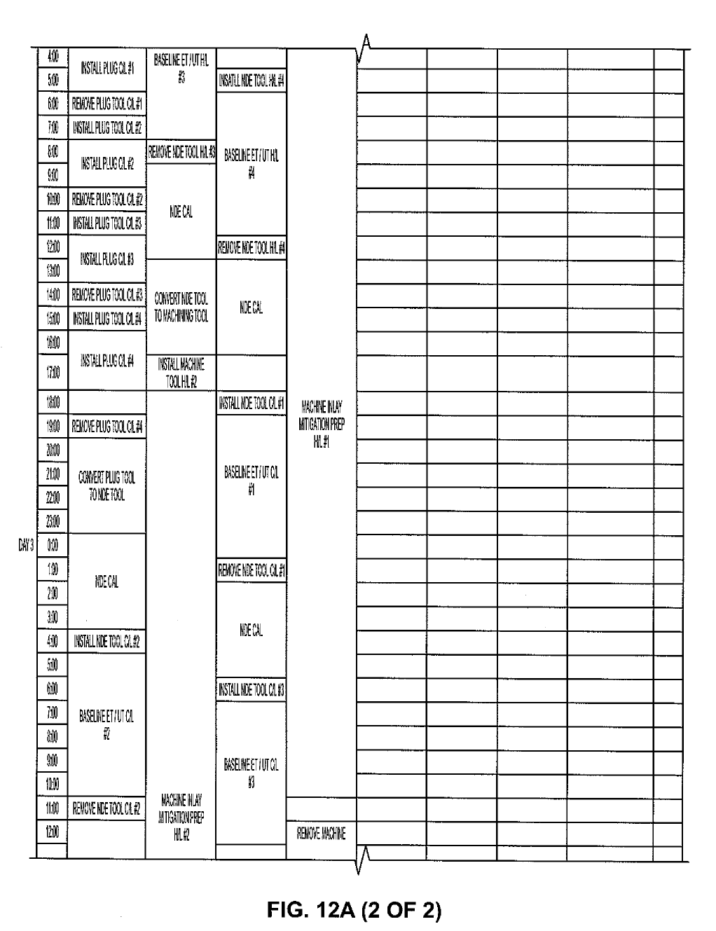

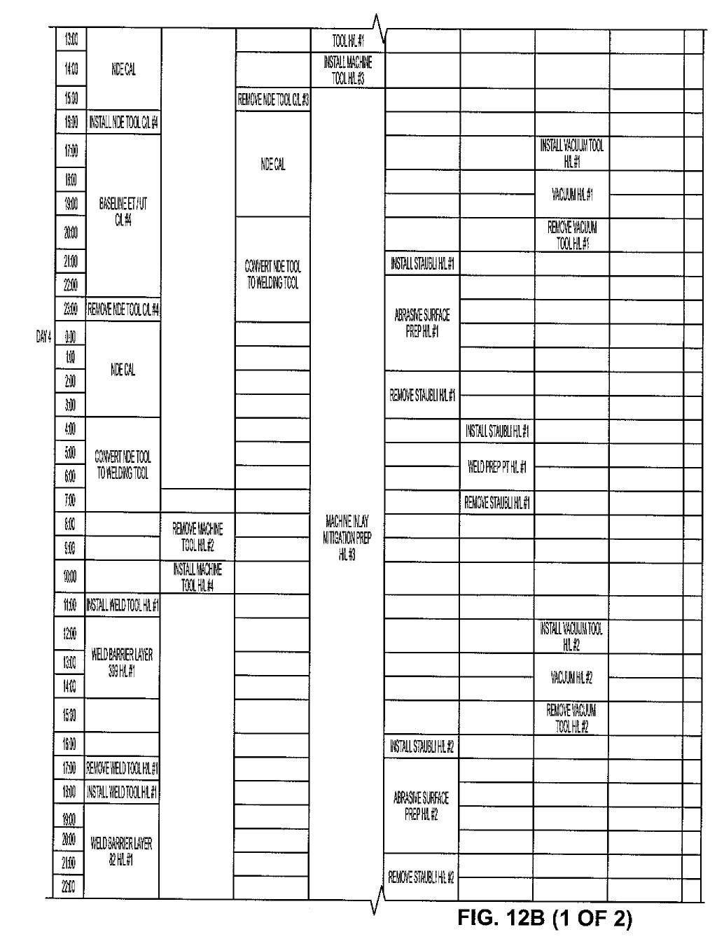

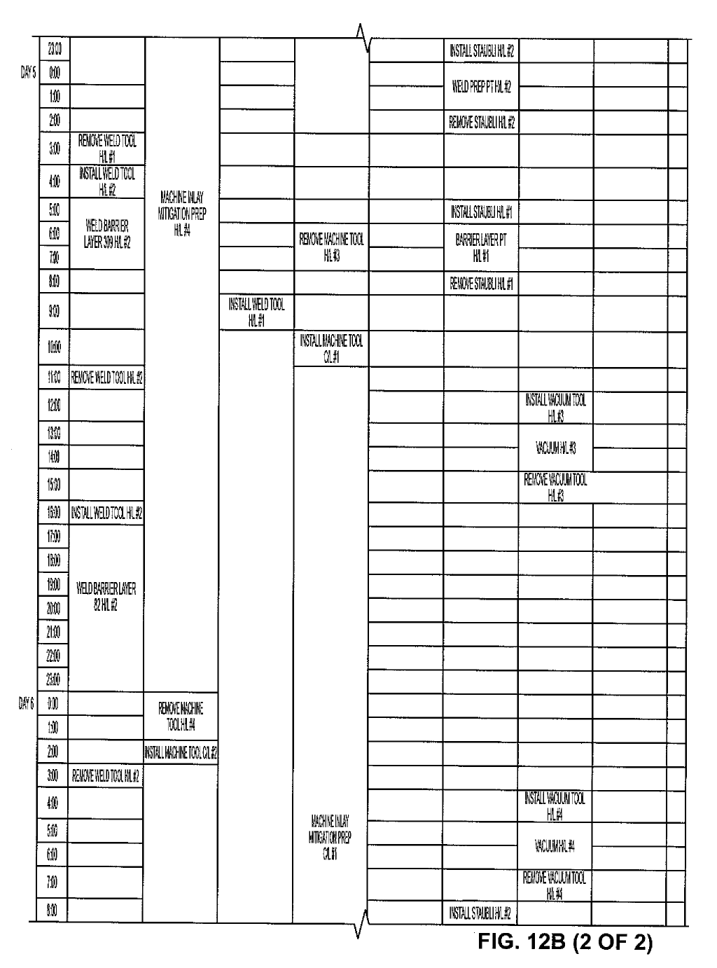

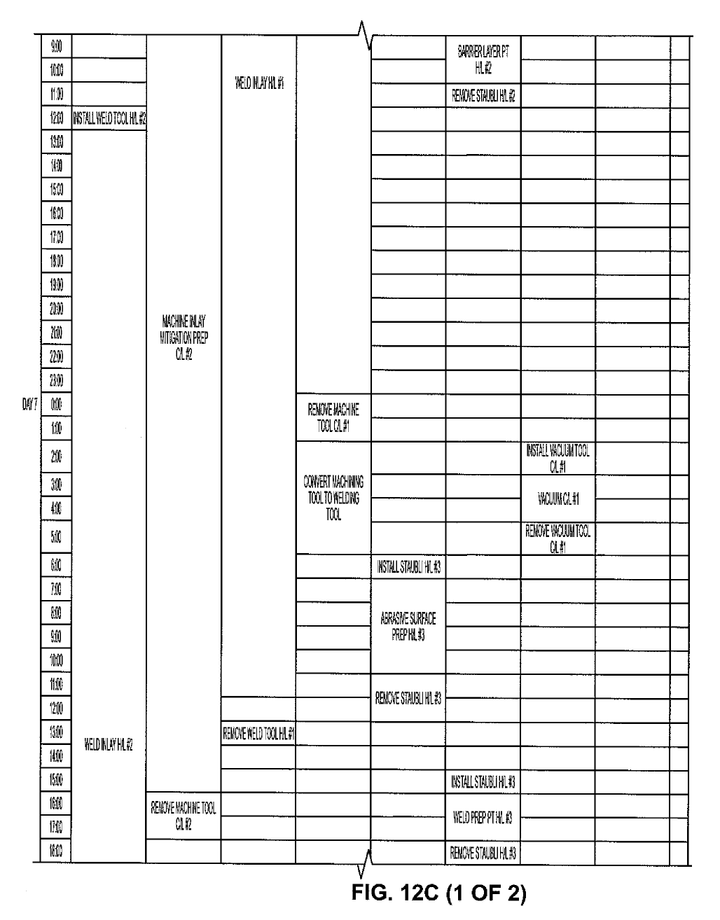

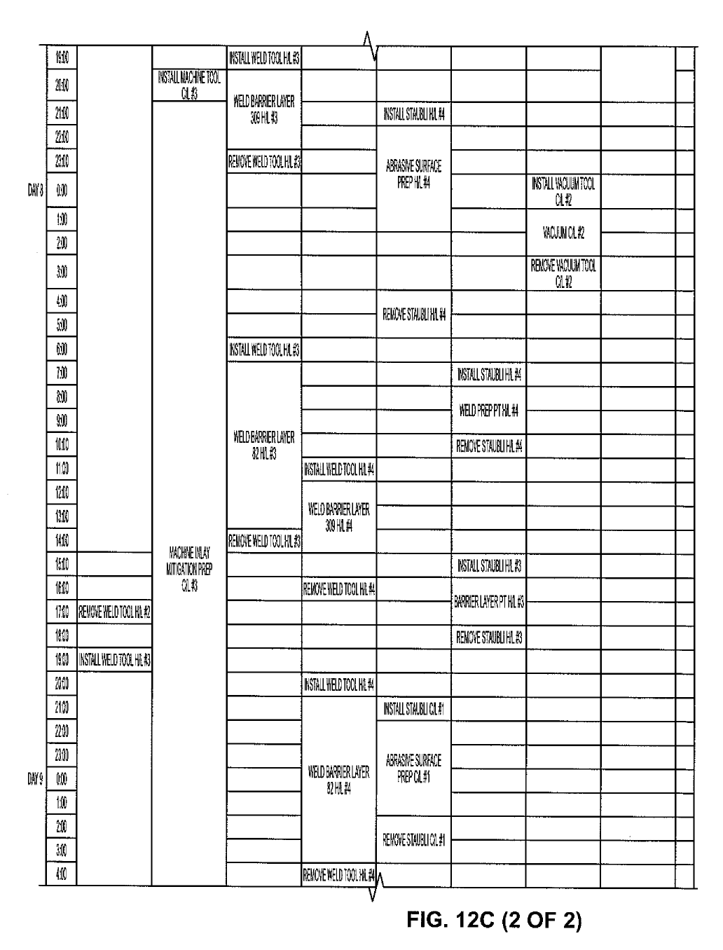

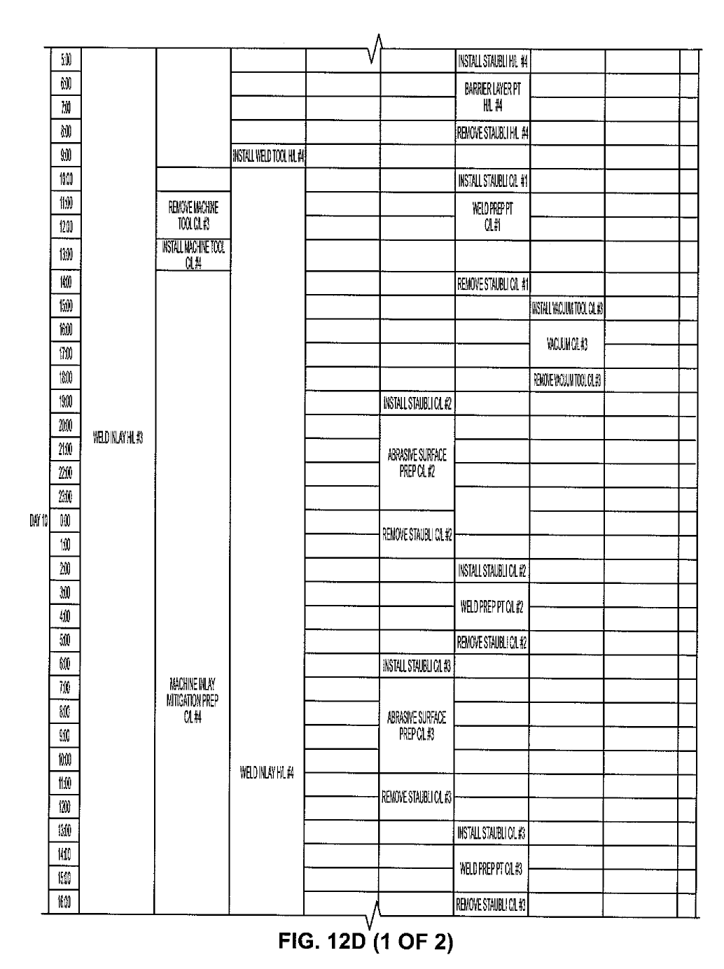

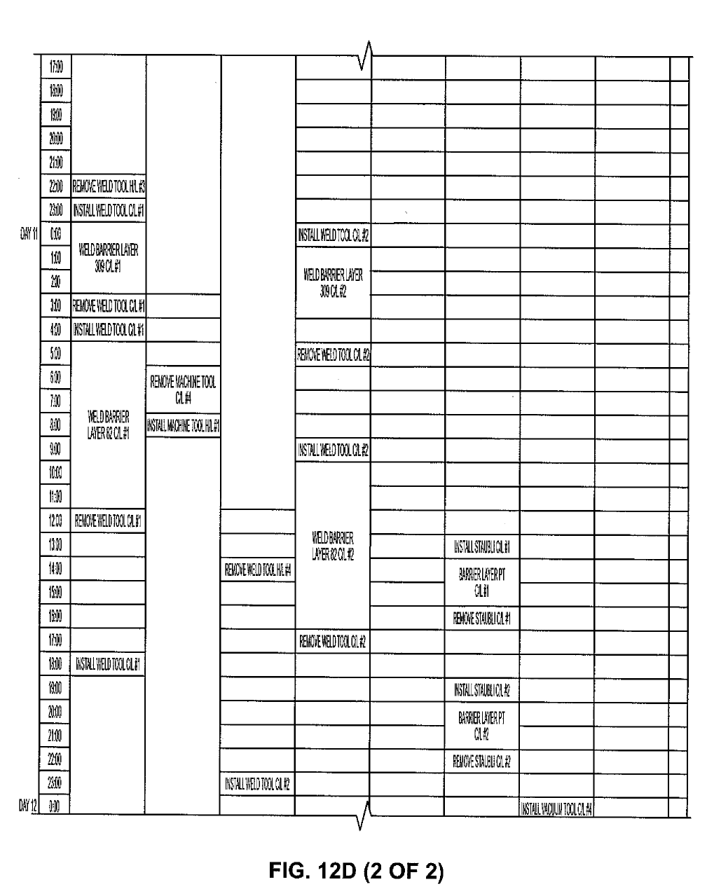

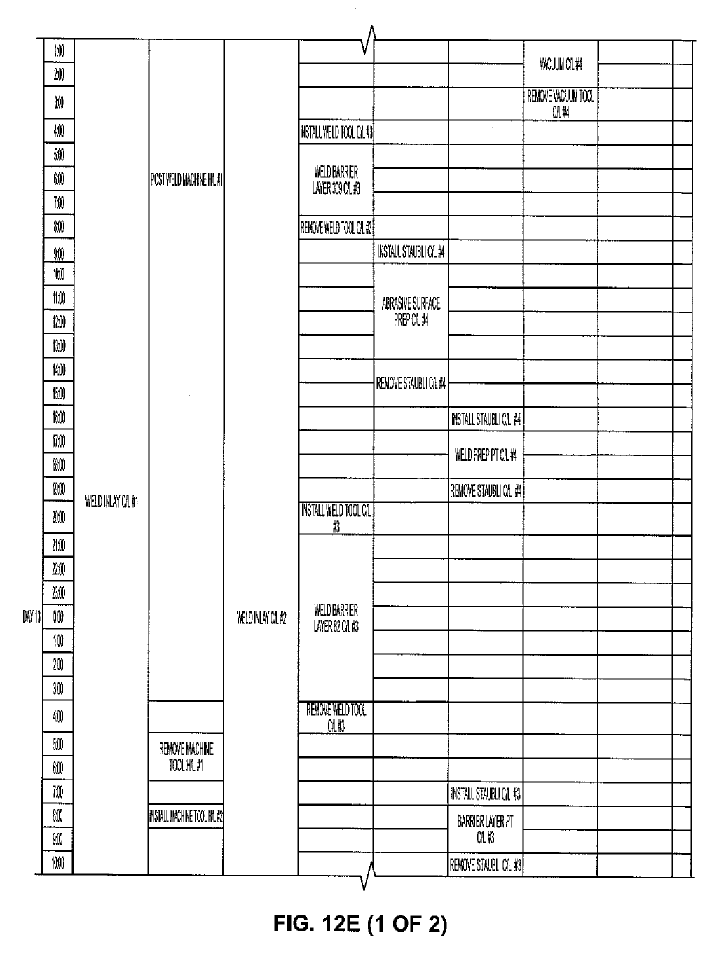

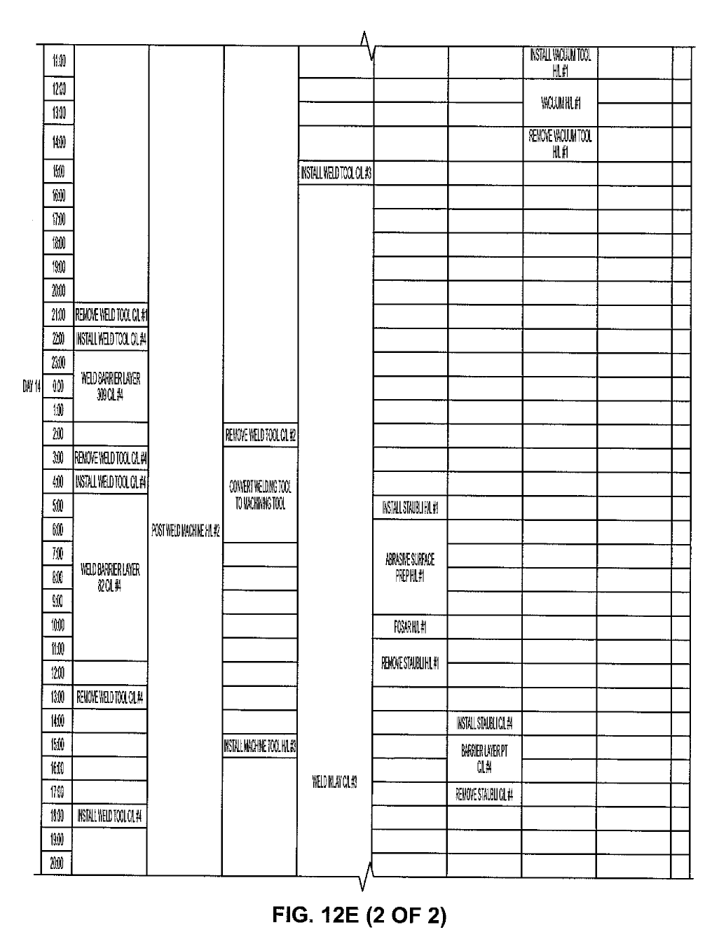

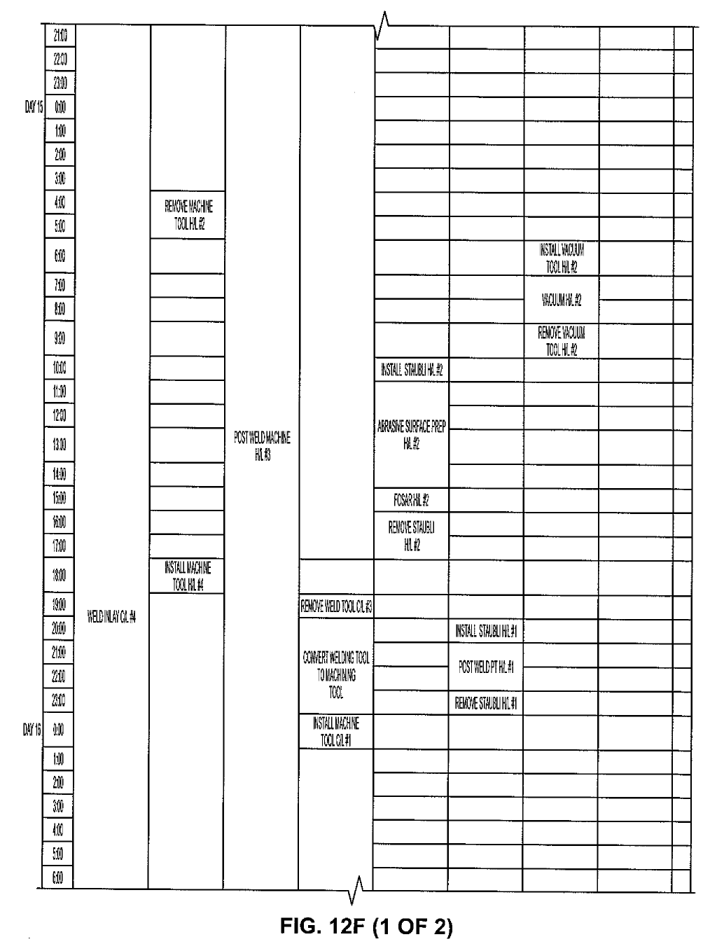

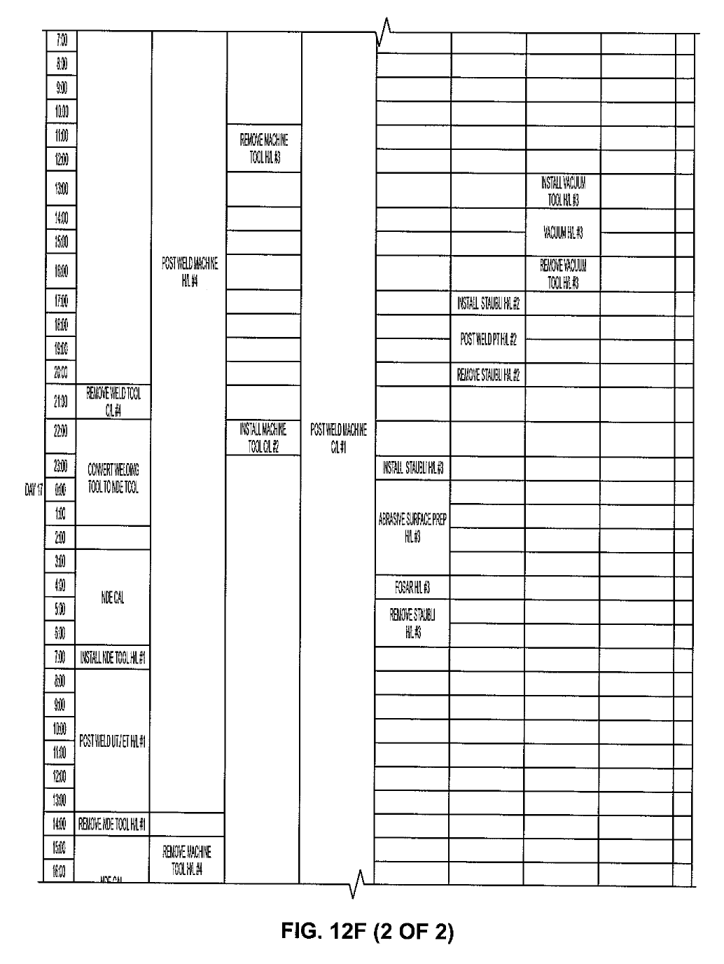

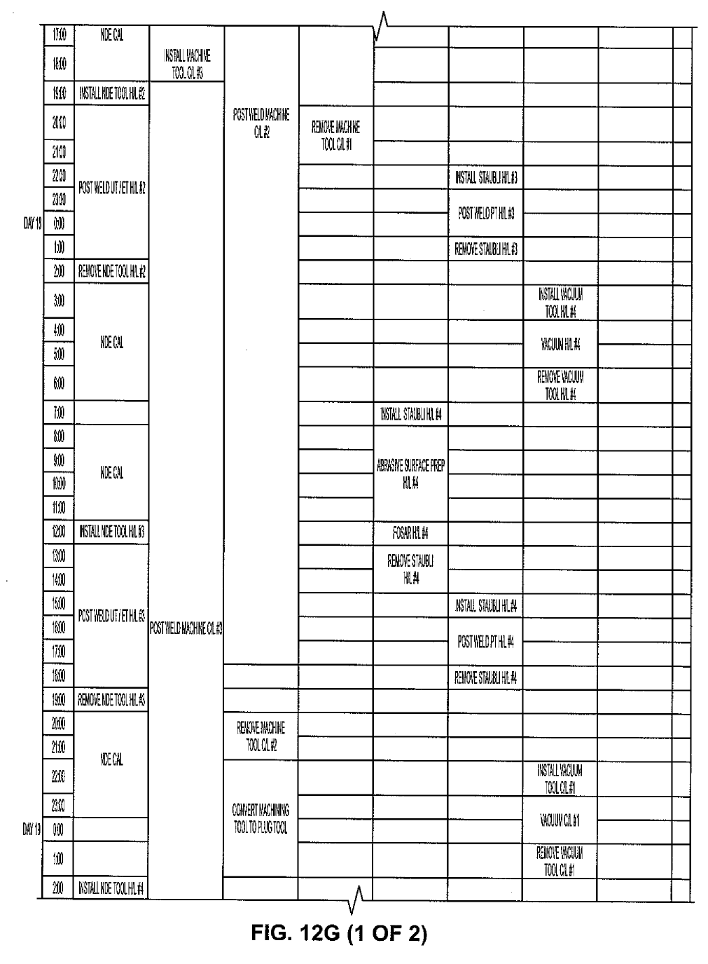

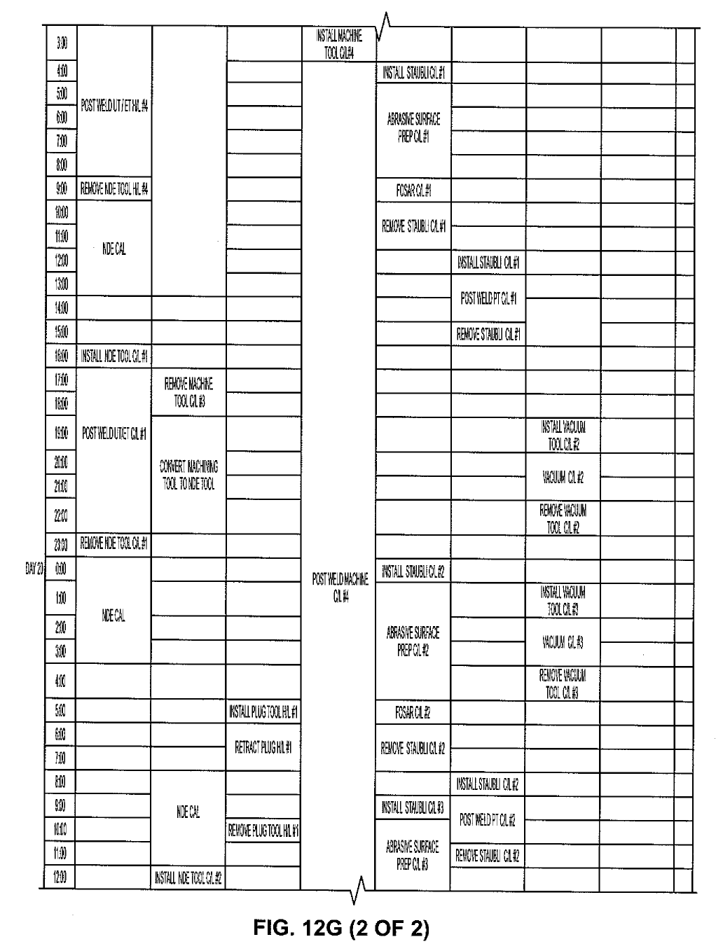

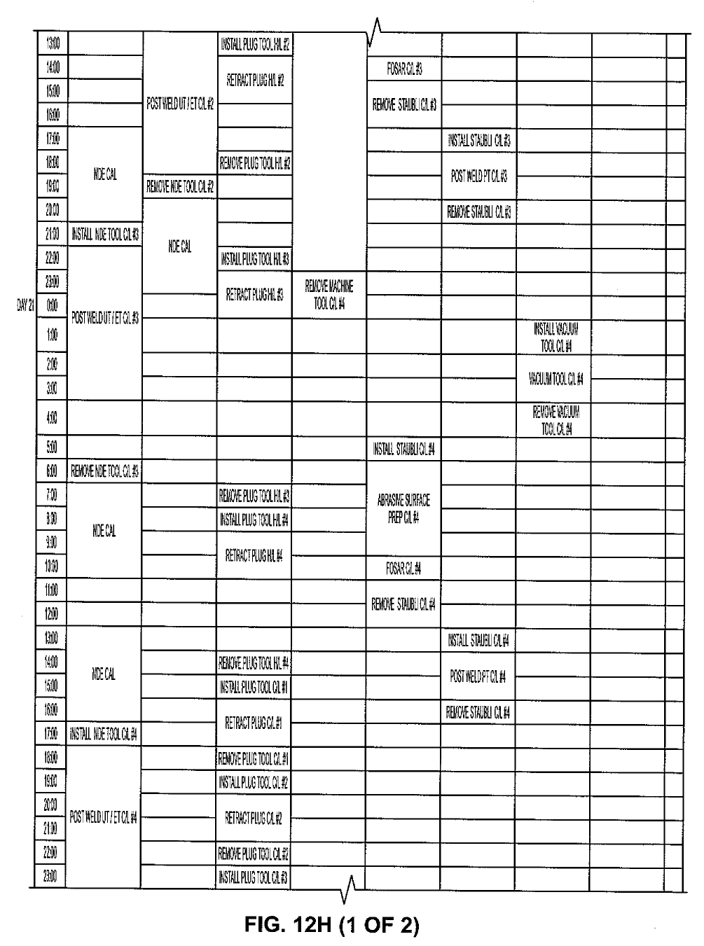

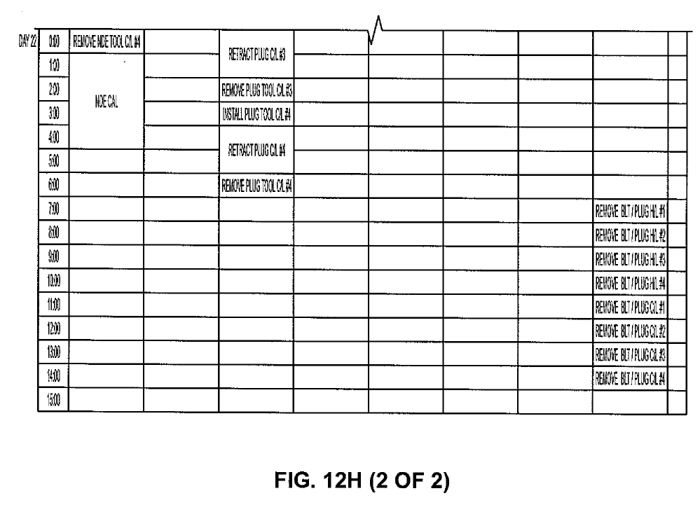

FIGS. 12A through 12H shows a preferred plan for performing a repair operation on eight primary nozzles using three common tool manipulators and one preparation robot at a same time, with four CTMs 90 and two preparation robots 200 being available for placement. The four CTMs are identified as CTMA, CTMB, CTMC and CTMD, and the two preparation robots as STAUBLIA and STAUBLIB. A vacuum tool is also used, thus completing the first seven columns. The plan will be described with respect to the operations on the first hot leg primary nozzle, although as shown all eight nozzles are processed.

As shown in the eighth column 8, the loading tubes 60 with plugs 70 are placed during hours zero to seven of the first day of the repair procedure.

As shown in the first column, the first CTMA then is used from hour seven to hour nineteen to install all of the plugs 70 in the four hot loop primary nozzles and four cold loop primary nozzles.

As shown in the second column, the second CTMB has an NDE head installed and calibrated at hour eight, and from hour twelve to hour twenty is used for a non-destructive examination of the primary nozzle weld in the first hot loop.

As shown in the third column, the third CTMC is then used to perform the NDE on the primary nozzle weld in the second hot loop from hour sixteen to the beginning of the second day.

Once CTMB is removed at hour twenty from the first hot loop nozzle (column two), the fourth CTMD shown in column four, with a machining head 97, is installed in the first hot loop nozzle and begins machining until hour ten of the third day.

As shown in column seven, the first hot loop nozzle is then vacuumed at hours sixteen to twenty of the third day. As shown in column five, the first preparation robot then can abrade the first hot leg primary nozzle surface from hour 20 on day three to hour three on day four, while thereafter the second preparation robot, as shown in column six, can wipe the abraded surface from hours four to six on the fourth day.

As shown in the first column, at hour 10 on the fourth day, the welding of a barrier layer of alloy 309 over any stainless steel material and alloy 82 over existing alloy 82/182 occurs. This barrier layer operation can proceed with CTMA until hour one on the fifth day. At this point the primary nozzle of the first hot leg primary has its barrier layers installed.

As shown in FIGS. 12B and 12C, third column, CTMC is then used to provide the weld inlay to the first hot leg from hour ten on day three to hour eleven on day four. As shown in FIGS. 12D and 12E, second column, at hour eight on day 11, the weld inlay in the first hot leg can be machined by CTMB until hour three on day thirteen.

Vacuuming can occur again in the first hot leg on day thirteen from hour eleven to hour thirteen, as shown in FIG. 12E. The first preparation robot then can abrade and FOSAR (foreign object search and retrieve) from hours five to ten on day fourteen. As shown in FIG. 12F, the final post-weld examination can occur using the second preparation robot on day fifteen from hours twenty to twenty-two, at which point the first primary nozzle is fully remediated with its new weld.

FIGS. 12F and 12G show final steps for all eight nozzles.

As shown for example at hour eight on day three, four nozzles can be occupied at once, by four CTMs. Alternately, four nozzles can be occupied by three CTM and one preparation robot, as shown for example at hour twenty-one on day three. Preferably, not more than half the nozzles are ever occupied, but at least half the nozzles are occupied by working devices during certain periods. This arrangement permits time-efficient use of the turntable, CTMs and preparation robots.

What is claimed is:

1. A method for providing welds to primary nozzles of a nuclear reactor comprising:
providing a first welding device in a first primary nozzle of the nuclear reactor;
providing a second welding device in a second primary nozzle of the nuclear reactor;
providing a third welding device in a third primary nozzle of the nuclear reactor; and
operating the first, second and third welding devices at the same time.

2. The method as recited in claim 1 wherein the first welding device is a welding head of a common tool manipulator.

3. The method as recited in claim 1 further comprising machining or grinding a weld in the first primary nozzle to remove weld material susceptible to PWSCC.

4. The method as recited in claim 1 wherein the first, second and third welding devices provide weld inlays or onlays over PWSCC susceptible weld material.

5. A method for providing welds to primary nozzles of a nuclear reactor comprising:
providing a first welding device in a first primary nozzle of the nuclear reactor;
providing a first pre-weld processing device in a second primary nozzle of the nuclear reactor; and
operating the first welding device and the first pre-weld processing device at the same time.

6. The method as recited in claim 5 wherein the first pre-weld processing device machines or grinds.

7. The method as recited in claim 5 wherein the first pre-weld processing device flaps a weld.

8. The method as recited in claim 5 wherein the first pre-weld processing device cleans a weld.

9. A method for providing welds to primary nozzles of a nuclear reactor comprising:
flapping a weld of a primary nozzle; and
welding the flapped surface using a tool manipulator located within the primary nozzle.

10. A method for providing welds to primary nozzles of a nuclear reactor comprising:
providing a barrier layer at a primary nozzle using a tool manipulator located within the primary nozzle; and
providing a further weld over the barrier layer using the tool manipulator or a further tool manipulator.

11. A method for providing welds to primary nozzles of a nuclear reactor comprising:
identifying a location of a weld of a primary nozzle;
fixing a locator in the primary nozzle as a function of the weld location;
placing a tool manipulator in the primary nozzle; and
locating the tool manipulator using the locator, the robot providing a weld.

12. A method for providing welds to primary nozzles of a nuclear reactor comprising:
providing a first working device in a first primary nozzle of the nuclear reactor;
providing a second working device in a second primary nozzle of the nuclear reactor;
providing a third working device in a third primary nozzle of the nuclear reactor; and
operating the first, second and third working devices at the same time.
